(19) United States
(12) Patent Application Publication
(10) Pub. No.: US 2009/0225169 A1
(43) Pub. Date: Sep. 10, 2009

(54) METHOD AND SYSTEM OF KEY FRAME EXTRACTION

(76) Inventor: Jin Wang, Shanghai (CN)

Correspondence Address: PHILIPS INTELLECTUAL PROPERTY & STANDARDS, P.O. BOX 3001, BRIARCLIFF MANOR, NY, 10510, US

(21) Appl. No.: 12/305,211

(22) PCT Filed: Jun. 26, 2007
(86) PCT No.: PCT/IB2007/052465

§ 371 Date: Dec. 17, 2008

(30) Foreign Application Priority Data
Jun. 29, 2006 (CN) 200610095682.4

(51) Int. Cl. H04N 17/00

(52) U.S. Cl. 348/180; 348/E17.001

(57) ABSTRACT

This invention proposes a method of extracting key frames from a video, said video comprising a set of video frames, said method comprising the steps of computing an error rate of each frame from said set of video frames, comparing said error rate of each frame with a predetermined threshold, identifying candidate frames that have an error rate below said predetermined threshold, and selecting some frames from said candidate frames to derive said key frames. By discarding frames that contain too many errors, the accuracy of key frame extraction is improved.

### FIELD OF THE INVENTION

The invention relates to a method and system for extracting key frames from a video. The invention may be used in the field of video processing.

### BACKGROUND OF THE INVENTION

Digital video is rapidly becoming an important source for the information era. As the volume of video data is growing, technology is needed to effectively browse video data in a short time without losing the content. A video may include a series of video frames each containing a video snapshot of an image scene. Key frames are typically defined to be an unordered subset of video frames representing the visual content of a video. Key frames are useful in video summarization, editing, annotation and indexing. Some of these have been manifested in the new multimedia standards including MPEG-4 and MPEG-7, both of which provide users with the flexibility of content-based video representation, coding and description.

One approach of key frame extraction is based on an arrangement of shots in the video. A shot may be defined as a continuously captured sequence of video frames. For example, a professionally produced video may be arranged into a set of carefully selected shots.

Another approach is also suitable for extracting key frames from short video clips or from amateur videos that are not carefully arranged, as disclosed in patent US2005/0228849A1. This approach includes selecting a set of candidate key frames from a series of video frames in a video by performing a set of analyses on each video frame. Each analysis is selected to detect a corresponding type of meaningful content in the video. The candidate key frames are then formed into a set of clusters and a key frame is then selected from each cluster in response to its relative importance in terms of depicting meaningful content in the video.

Unfortunately, one inherent problem with any communication system is that information may be altered or lost during transmission due to channel noise. Therefore, in the application related to broadcasting and storage, random errors will have negative effects on the picture data. When there are some errors on frames or even the errors are recovered, if the basic key frame extraction is used, recovered frames will have negative effects on the accuracy of key frame extraction. It is not appropriate to consider these pixels when they are corrupt or not correctly recovered.

### OBJECT AND SUMMARY OF THE INVENTION

It is an object of this invention to provide a method of extracting key frames from a video in a more efficient way.

To this end, there is proposed a method of extracting key frames from a video, said video comprising a set of video frames, said method comprising the steps of computing an error rate of each frame from said set of video frames, comparing said errors rate of each frame with a predetermined threshold, identifying candidate frames that have an error rate below said predetermined threshold, and selecting some frames from said candidate frames to derive said key frames.

Also proposed is a system comprising units that have functionalities defined by features of the method according to the invention.

By discarding frames that have too many errors, the accuracy of key frame extraction is improved. Therefore, this invention provides a more robust key frame extraction method.

### BRIEF DESCRIPTION OF THE DRAWINGS

FIG. 1 shows a flowchart of a first method according to the invention of extracting key frames from a video.

FIG. 2 shows a flowchart of a second method according to the invention of extracting key frames from a video.

FIG. 3 shows a flowchart of a third method according to the invention of extracting key frames from a video.

FIG. 4 illustrates in an example a video with a predetermined area.

FIG. 5 depicts a schematic diagram of a system according to the invention for extracting key frames from a video.

### DETAILED DESCRIPTION OF THE INVENTION

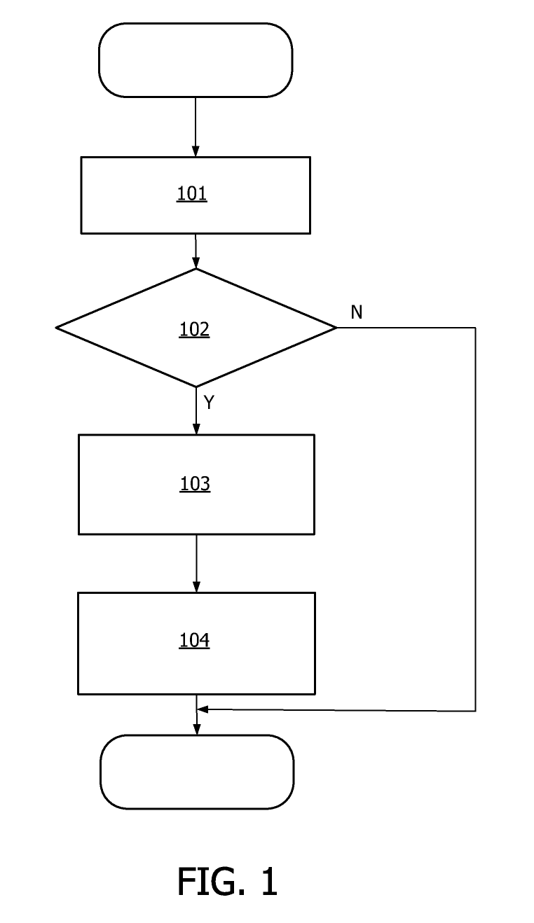

FIG. 1 shows a flowchart of a first method according to the invention of extracting key frames from a video.

This invention provides a method of extracting key frames from a video, said video comprising a set of video frames, said method comprising a step of computing (101) an error rate of each frame from said set of video frames. The errors are firstly detected, and then the detected errors are summed up to reach a number of errors. The method of error detection is already known. For example, the syntax-based error detector (SBED) can be used to detect errors. Errors in a Fixed Length Codeword (FLC) can be detected if its value is undefined or forbidden according to its codeword table. An error in a Variable Length Codeword (VLC) can also be detected if it is not included in its codeword table or more than 64 DCT (Discrete Cosine Transform) coefficients appear in one block. Detected errors may form a error map, and said error rate is computed according to this error map.

This method also comprises a step of comparing (102) said error rate of each frame with a predetermined threshold. Said threshold, for example, according to a test of the invention, may be 30%.

The error rate mentioned at step 101, for example, may be the ratio between the number of MB that have errors and the total number of MB in each frame. Alternatively, it may also be a number of errors in each frame. Accordingly, the threshold mentioned at step 102 may be a ratio in a former situation and may be a number in a later situation.

This method also comprises a step of identifying (103) candidate frames that have an error rate below said predetermined threshold.

The frames that have too many errors have to be discarded. For example, the candidate frames that have an error rate lower than said predetermined threshold are flagged with “0” in the error map, and these frames (as candidate frames), will be considered during the process of selecting key frames.

Finally, this method comprises a step of selecting (104) some frames from said candidate frames to derive said key frames. For example, it only selects key frames from those frames flagged “0”. The method of selecting key frames from some frames is known, for example, as stated before, US20050228849 discloses a method for intelligent extraction of key-frames from a video that yields key-frames that depict meaningful content in the video.

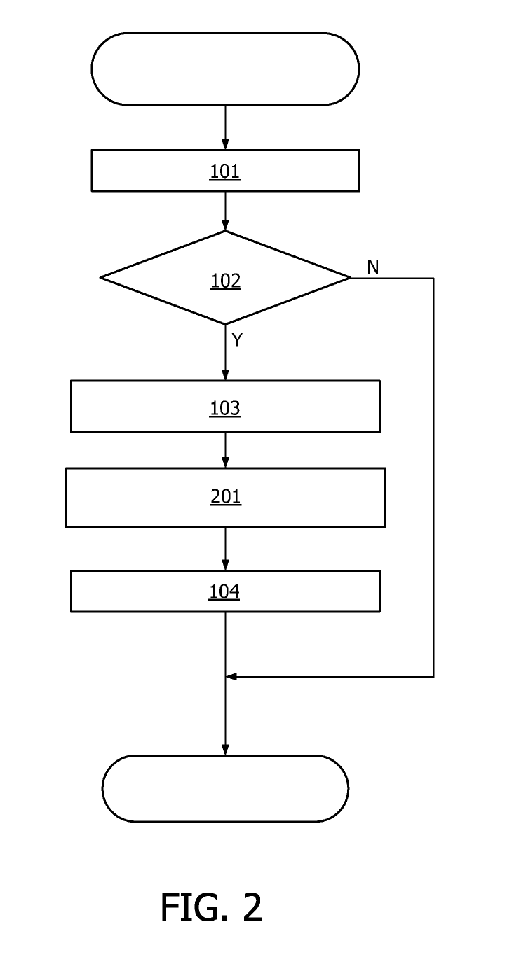

FIG. 2 shows a flowchart of a second method according to the invention of extracting key frames from a video.

FIG. 2 is based on that of FIG. 1 in which an additional step (201) has been added.

This method further comprises, before the step of selecting (104), a step of discarding (201) candidate frames resulting from a previous error recovery and still containing artefacts.

For frames that have an error rate lower than the predetermined threshold, some of them are still discarded if the errors are not recovered well.

Frames can be encoded in three types: intra-frames (I-frames), forward predicted frames (P-frames), and bi-directional predicted frames (B-frames). An I-frame is encoded as a single image, with no reference to any past or future frames. A P-frame is encoded relative to the past reference frame. A B-frame is encoded relative to the past reference frame, the future reference frame, or both frames.

For I-frame, different recovery methods may apply according to different Macroblock (MB). After recovery, some frames may still contain artefacts. An artefact is a distortion in an image by quantization error, the limitation or malfunction in the hardware or software, such as JPEG and MPEG. For the texture of a MB in an I-frame, if a spatial interpolation error concealment method is applied, the quality of recovery is not good for key frame extraction. The frames containing this kind of MB (artefact) should be discarded.

For an edge of a MB in an I-frame, if an edge-based spatial interpolation error concealment method is applied, the quality of recovery is not good for key frame extraction. The frames with this kind of MB (artefact) should be discarded.

In the event of P and B frames: In most cases, the method of Temporal Error Concealment is used. The errors can be recovered better. The number of recovered pixels can be considered during key frame extraction.

The discarded frames may be flagged “1”.

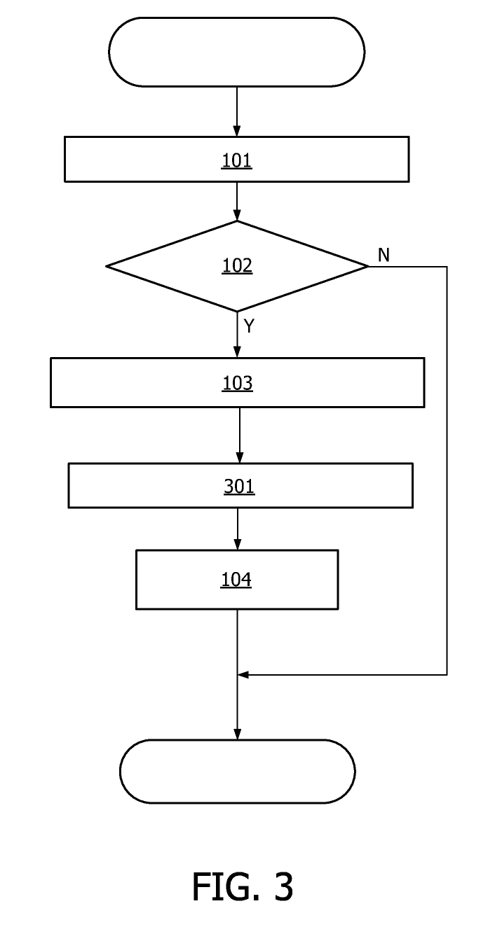

FIG. 3 shows a flowchart of a third method according to the invention of extracting key frames from a video.

The flowchart of FIG. 3 is also based on that of FIG. 1 in which an additional step (301) has been added.

This method also comprises, before selecting step (104), a step of discarding (301) frames that have errors located in a predetermined area.

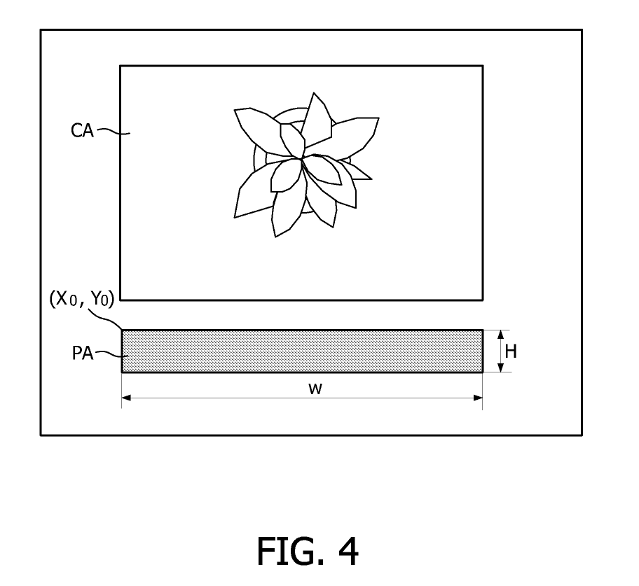

FIG. 4 illustrates in an example a video with a predetermined area.

The predetermined area, represented by “PA” in FIG. 4, may comprise text information, wherein “CA” represents the content area.

Having some errors in an area containing some text has negative effects on the accuracy of key frame extraction.

If errors happen in a predetermined area (PA), such as a subtitle area defined by a starting point of (X₀, Y_{O})/width (represented by “W”)/height (represented by “H”), the frames containing this kind of errors are discarded.

The discarded frames may be flagged “1”.

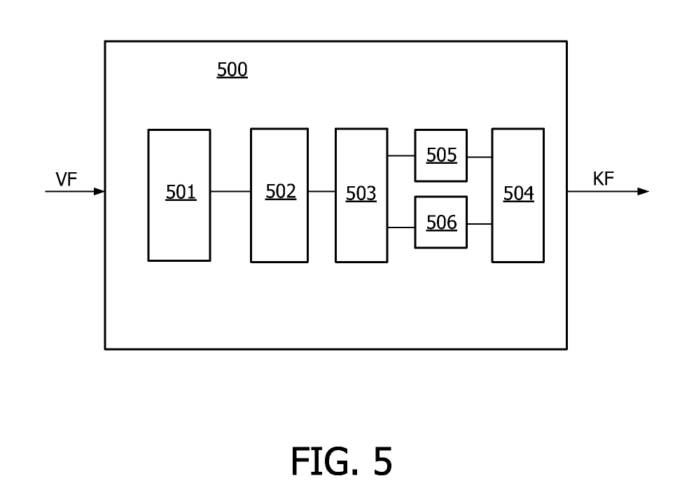

FIG. 5 depicts a schematic diagram of a system according to the invention for extracting key frames from a video.

This invention provides a system (500) for extracting key frames from a video, said video comprising a set of video frames, said system comprising a computing unit (501) for computing an error rate of each frame from said set of video frames. The computing unit (501) may be a processor, for example, processing a set of video frames (represented by “VF” in FIG. 5) which has been decoded, summing up the errors detected by a detector, such as the syntax-based error detector (SBED), and computing the error rate.

The system (500) also comprises a comparing unit (502) for comparing said error rate of each frame with a predetermined threshold. The comparing unit (502) may be a processor and may also comprise a memory for storing the predetermined threshold.

The system (500) also comprises an identifying unit (503) for identifying candidate frames that have an error rate lower than said predetermined threshold. The identifying unit (503) may be a processor. The identifying unit (503) may, for example, mark candidate frames that have an error rate lower than said predetermined threshold and flag them “0”.

The system (500) also comprises a selecting unit (504) for selecting some frames from said candidate frames to derive said key frames. Key Frames (Represented by “KF” in FIG. 5) is selected, for example, from the frames flagged “0”. The selecting unit (504) may be a processor.

The system (500) also comprises a first discarding unit (505) for discarding candidate frames resulting from a previous error recovery and still containing artefacts. The discarding unit (505), for example, may flag these frames with a “1”.

The system (500) also comprises a second discarding unit (506) for discarding frames that have errors located in a predetermined area. The discarding unit (506), for example, may flag these frames with a “1”.

The system (500) can be integrated into the decoder and help improve key frame extraction. In fact, it can be also be independent of the decoder, i.e., the error map can be kept in the storage. During key frame extraction, the error map is accessed to improve the accuracy of key frame operation.

While the invention has been illustrated and described in detail in the drawings and above description, such illustrations and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims. In the claims, the word “comprising” or “comprises” does not exclude other elements or steps, and the indefinite article “a’ or “an” does not exclude a plurality. A single processor or other unit may fulfil the functions of several items recited in the claims. The mere fact that certain measures are recited in mutually different dependent claims does not indicate that a combination of these measured cannot be used to advantage. Any reference signs in the claims should not be construed as limiting the scope.

1. A method of extracting key frames from a video, said video comprising a set of video frames, said method comprising the steps of:
computing (101) an error rate of each frame from said set of video frames;
comparing (102) said error rate of each frame with a predetermined threshold;
identifying (103) candidate frames that have an error rate below said predetermined threshold; and
selecting (104) some frames from said candidate frames to derive said key frames.

2. A method as claimed in claim 1, further comprising, before the selecting step (104), a step of discarding (201) candidate frames resulting from a previous error recovery and still containing artefacts.

3. A method as claimed in claim 2, wherein said set of video frames are intra-frames, wherein said previous error recovery corresponds to a spatial interpolation error concealment, said artefacts being located in the texture of a Macroblock (MB).

4. A method as claimed in claim 2, wherein said set of video frames are intra-frames, wherein said previous error recovery corresponds to a spatial interpolation error concealment, said artefacts being located at an edge of a Macroblock (MB).

5. A method as claimed in claim 1, further comprising, before the selecting step (104), a step of discarding (301) candidate frames that have errors located in a predetermined area.

6. A method as claimed in claim 1, wherein said predetermined area corresponds to an area containing text information.

7. A method as claimed in claim 1, wherein said error rate is the ratio of the number of Macroblocks in a frame that have some errors to the total number of Macroblocks in said frame, and said predetermined threshold is approximately equal to 30%.

8. A system for extracting key frames from a video, said video comprising a set of video frames, said system comprising:
a computing unit (501) for computing an error rate of each frame from said set of video frames;
a comparing unit (502) for comparing said error rate of each frame with a predetermined threshold;
an identifying unit (503) for identifying candidate frames that have an error rate lower than said predetermined threshold; and
a selecting unit (504) for selecting (104) some frames from said candidate frames to derive said key frames.

9. A system as claimed in claim 8, further comprising
a first discarding unit (505) for discarding candidate frames resulting from a previous error recovery and still containing artefacts.

10. A system as claimed in claim 9, wherein said set of video frames are intra-frames, wherein said previous error recovery corresponds to a spatial interpolation error concealment, said artefacts being located in the texture of a Macroblock (MB).

11. A system as claimed in claim 9, wherein said set of video frames are intra-frames, wherein said previous error recovery corresponds to a spatial interpolation error concealment, said artefacts being located at an edge of a Macroblock (MB).

12. A system as claimed in claim 8, further comprising:
a second discarding unit (506) for discarding frames that have errors located in a predetermined area.

13. A system as claimed in claim 12, wherein said predetermined area corresponds to an area containing text information.
